(19) United States
(12) Patent Application Publication
(10) Pub. No.: US 2007/0170735 A1
(43) Pub. Date: Jul. 26, 2007

(54) Slot machine baton

(76) Inventor: Timothy D. Walker, Potomac Falls, VA (US)

Correspondence Address: LITMAN LAW OFFICES, LTD., P.O. BOX 15035, CRYSTAL CITY STATION, ARLINGTON, VA, 22215, US

(21) Appl. No.: 11/589,884

(22) Filed: Oct. 31, 2006

Related U.S. Application Data
(60) Provisional application No. 60/762,116, filed on Jan. 26, 2006.

(51) Int. Cl. B25J 1/00

(52) U.S. Cl. 294/19.1

(57) ABSTRACT

The slot machine baton or stick includes an engagement head attached to a distal end of an elongated shaft, with a gripping handle attached to a proximal end of the elongated shaft. The slot machine baton or stick allows a user to control a game machine even when the user is positioned a distance away from the game controls. The user grips and moves the gripping handle to remotely move and control the engagement head, which may be weighted, in order to releasably engage and contact the game controls. The user may actuate the game controls even when seated without having to change bodily position. The head and the handle are removably attached to the shaft to interchange parts to alter the length, shape, configuration, and weight of the baton or stick.

### CROSS-REFERENCE TO RELATED APPLICATION

This application claims the benefit of U.S. Provisional Patent Application Ser. No. 60/762,116, filed Jan. 26, 2006.

### BACKGROUND OF THE INVENTION

1. Field of the Invention

The present invention relates to reaching tools, and particularly to a slot machine tool that enables a slot machine player to reach the handle or actuator button of a slot machine or other gaming machine while seated in a chair at a distance from the machine.

2. Description of the Related Art

Gaming devices, such as slot machines and video games, are typically located in casinos, video arcades and other similar locales, which do not provide the user with many alternatives regarding access to the gaming systems. Most gaming devices are designed and positioned to allow a user access only in the standing position. However, the player may become easily fatigued when standing in front of slot machines for extended periods of time. The player may wish to sit down to relieve the burden on his or her feet, but often the only chairs available are not at a convenient height for playing the machine. Consequently, the player must lean forward to depress the buttons and then lean back to relax until the display stabilizes. The constant cycle of leaning forward and leaning back is far more enervating than simply standing.

The handicapped person confined to a wheelchair faces similar problems when playing gaming machines. The wheelchair often sits so low that the player must lean forward and stretch to reach the actuator button or handle of the gaming machine. Further, given the high amount of traffic in casinos and video arcades, a very large number of people play a single machine in one day. Each person actuates the same button or buttons on the machine, and thus the actuating button or buttons become unsanitary and unhygienic. These machines are typically not cleaned by the proprietors of the casinos and arcades, thus the users are forced to make physical contact with an unsanitary surface in order to play the game.

In addition, particularly in the case of gambling machines, such as slot machines or computerized card games, a user often wishes to play multiple games at once. The user is typically prevented from accessing multiple game machines at once while remaining in a seated or steady position. Thus, a slot machine tool, such as a baton or stick, solving the aforementioned problems is desired.

### SUMMARY OF THE INVENTION

The slot machine baton or stick includes an engagement head attached to the distal end of an elongated shaft, with a gripping handle attached to a proximal end of the elongated shaft. The slot machine baton or stick allows a user to control a game machine even when the user is positioned a distance away from the game controls. The user holds the baton or stick by the gripping handle in order to remotely move and control the engagement head, which may be weighted, in order to releasably engage and contact the game controls. The gripping handle and engagement head may be releasably attached to the elongated shaft, allowing for interchangeability with a plurality of engagement heads, elongated shafts and gripping handles, each having unique configurations suitable to the specific needs of the user.

Further, the elongated shaft may have an adjustable length and angular position with respect to the engagement head, allowing the user to adapt the elongated tool for use in a wide variety of environments. The engagement head, elongated shaft and gripping handle may all have indicia imprinted thereon for purposes of identification or advertising. Through use of the slot machine baton or stick, the user may actuate the game controls, even when seated, without having to change bodily position.

These and other features of the present invention will become readily apparent upon further review of the following specification and drawings.

### BRIEF DESCRIPTION OF THE DRAWINGS

FIG. 1 is an environmental, perspective view of a slot machine baton or stick according to the present invention.

FIG. 2 is a side elevational view of the slot machine baton or stick of the present invention.

FIG. 3 is a side elevational view of a second embodiment of a slot machine baton or stick according to the present invention.

FIG. 4 is a partially exploded view of the slot machine baton or stick of FIG. 3.

FIG. 5 is a side elevational view of the slot machine baton or stick of the embodiment of FIG. 2 including an optional cover member.

FIG. 6A is a perspective view of a third embodiment of a slot machine baton or stick according to the present invention, partially exploded to show releasable attachment of the gripping handle.

FIG. 6B is a perspective view of the embodiment of FIG. 6A, partially exploded to show releasable attachment of the engagement head.

FIG. 7A is a side elevational view of a fourth embodiment of a slot machine baton or stick of the present invention.

FIG. 7B is a side elevational view of a fifth embodiment of a slot machine baton or stick of the present invention.

FIG. 7C is a side elevational view of a sixth embodiment of a slot machine baton or stick according to the present invention.

FIG. 8 is a side elevational view of an alternative embodiment of the slot machine baton or stick of FIG. 5.

Similar reference characters denote corresponding features consistently throughout the attached drawings.

### DETAILED DESCRIPTION OF THE PREFERRED EMBODIMENTS

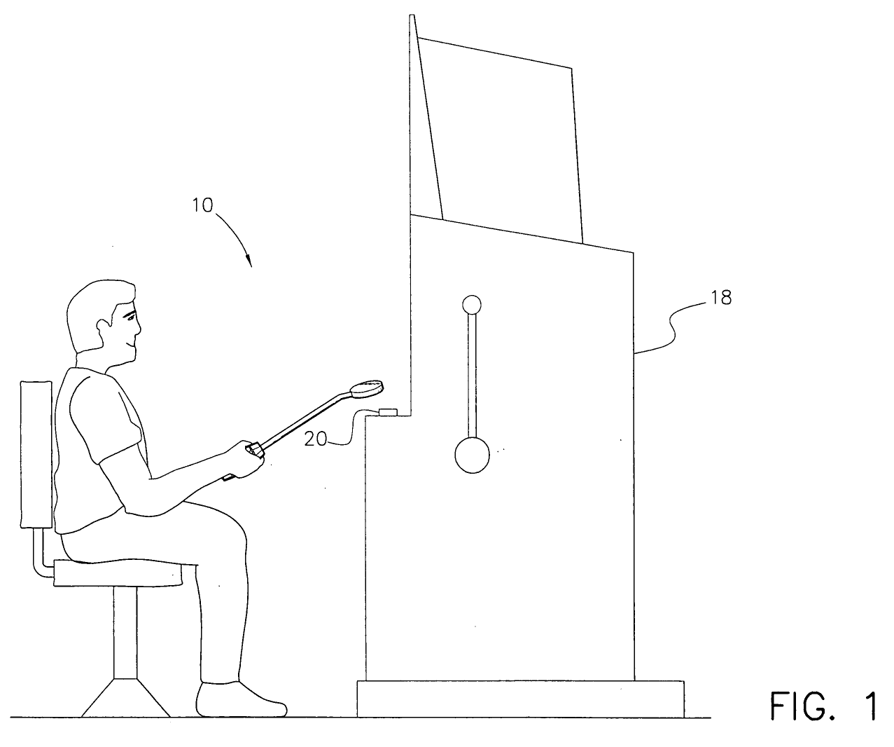

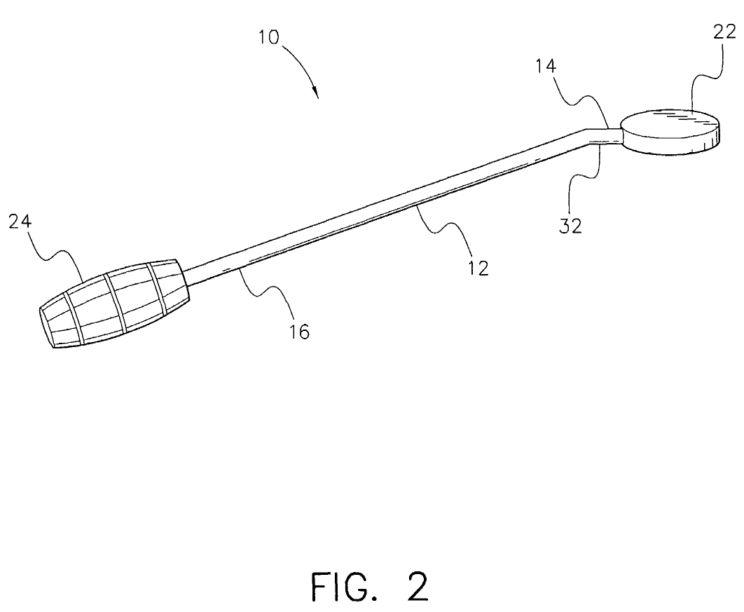

Referring to FIGS. 1 and 2, a first embodiment of a slot machine baton or stick 10 includes an elongated shaft 12 having an engagement head 22 attached to a distal end thereof, and a gripping handle 24 attached to a proximal end thereof. Device 10 is a baton, stick or any other elongated actuation device, allowing the user to remotely operate a control or button. As shown in FIG. 1, baton or stick 10 may be held and manipulated by a user in order to engage and actuate a control 20 of a slot machine or other game machine 18. The elongated shaft 12 allows the user to be positioned at a distance from the game machine 18, thus preventing strain on the user's back and allowing the user to play game machine 18 while remaining in the seated position. Slot machine baton or stick 10 may be used by disabled users who cannot ordinarily reach control 20, or may be used by users who otherwise do not have ready access to game machine 18. Further, slot machine baton or stick 10 allows a user to be seated in front of one game machine and actuate an adjacent machine without having to stand or otherwise contort the body. Although shown is use with a slot machine in FIG. 1, it should be understood that slot machine baton or stick 10 may be used with any type of game machine 18 having a an actuator button 20, handle, or other actuator control.

Slot machine baton or stick 10 is formed from a lightweight, durable material, allowing the user to easily grasp and manipulate the baton or stick 10. Such materials include wood, plastic, lightweight metals, such as aluminum, or any other suitable materials and combinations thereof. The selection of materials utilized in the construction of slot machine baton 10 are dependent upon the needs and desires of the user.

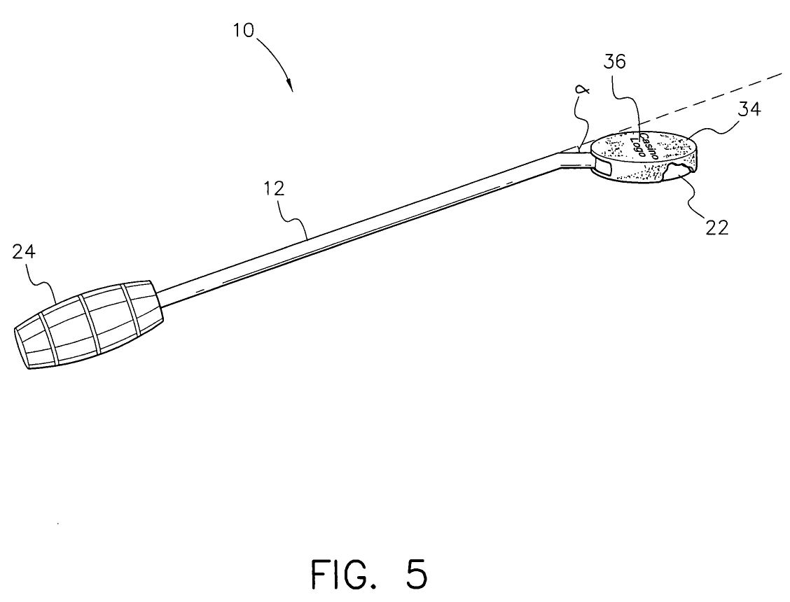

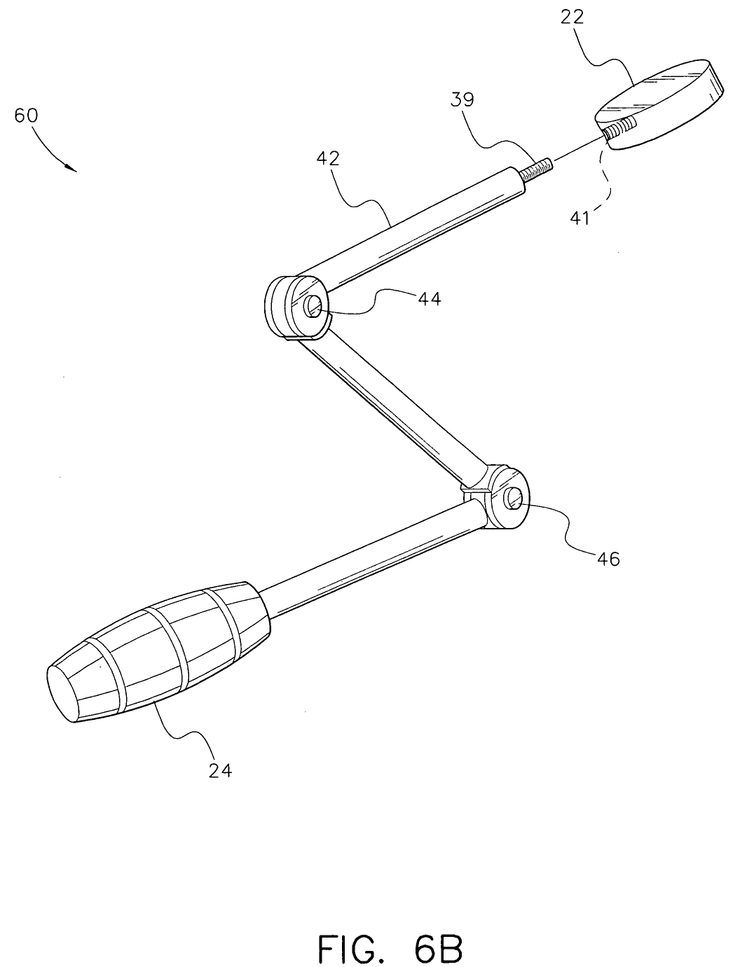

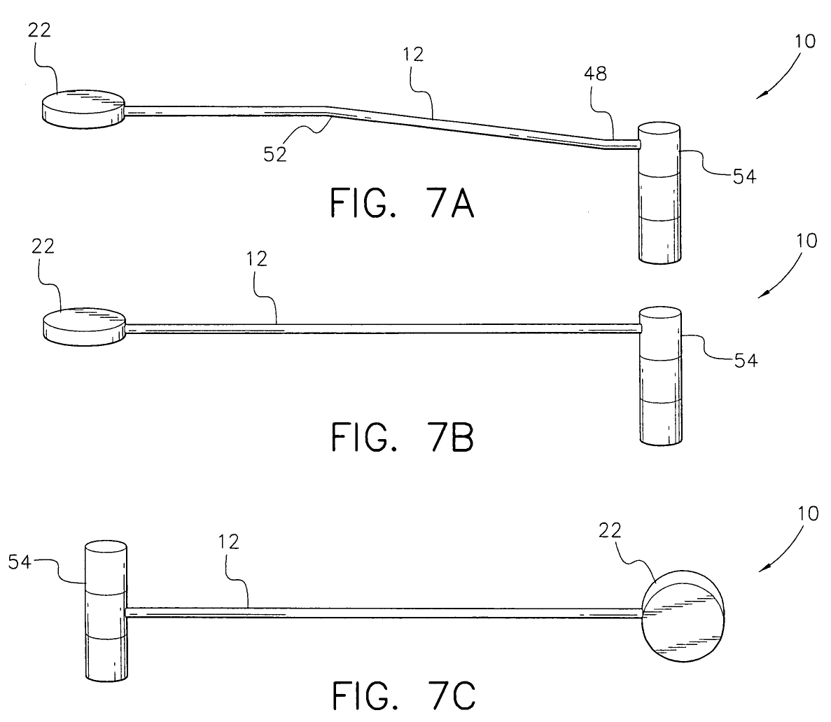

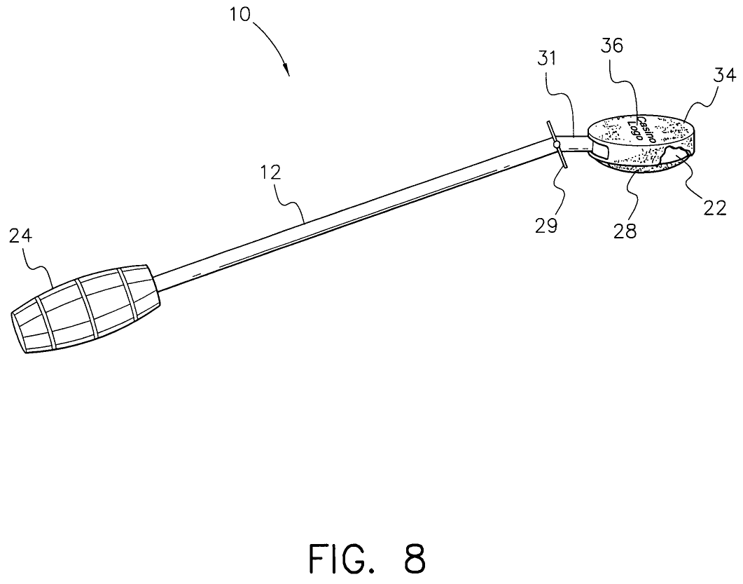

As best shown in FIG. 2, engagement head 22 is attached to the distal end 14 of elongated shaft 12, allowing the user to control a game by movement of engagement head 22, even when the user is spaced apart from the game and game controls. Elongated shaft 12 may be a straight rod (as will be described in further detail below, with regard to the embodiment of FIGS. 7B and 7C), or may include a bend 32, thus providing for angular displacement of the distal end 14 and engagement head 22 with respect to the remainder of the shaft 12. In the seated position, shown in FIG. 1, the user benefits from the angular displacement of engagement head 22, in that the user may remain seated and easily utilize baton or stick 10 to actuate control 20. However, the user may need to stand or remain in another position, or may desire to use a differently configured game, in a different shaft may be desired. Elongated shaft 12 may be interchangeable (as will be described in further detail below), allowing for shafts of different lengths and shapes to be utilized, depending on the particular needs of the user. In one embodiment, engagement head 22 is angularly displaced from the axis of elongated shaft 12 by approximately 20° to 45° (shown as angle α in FIG. 5). Alternatively, engagement head 22 may be pivotally adjusted by the user to a selected angle of displacement.

As shown in the alternative embodiment of FIG. 7A, the elongated shaft 12 includes two bent regions, namely, 48 and 52. FIGS. 7B and 7C illustrate another alternative embodiment in which elongated shaft 12 is formed as a straight rod. As will be described in further detail below, the elongated shaft may be interchangeable with other elongated shafts having different lengths and shapes.

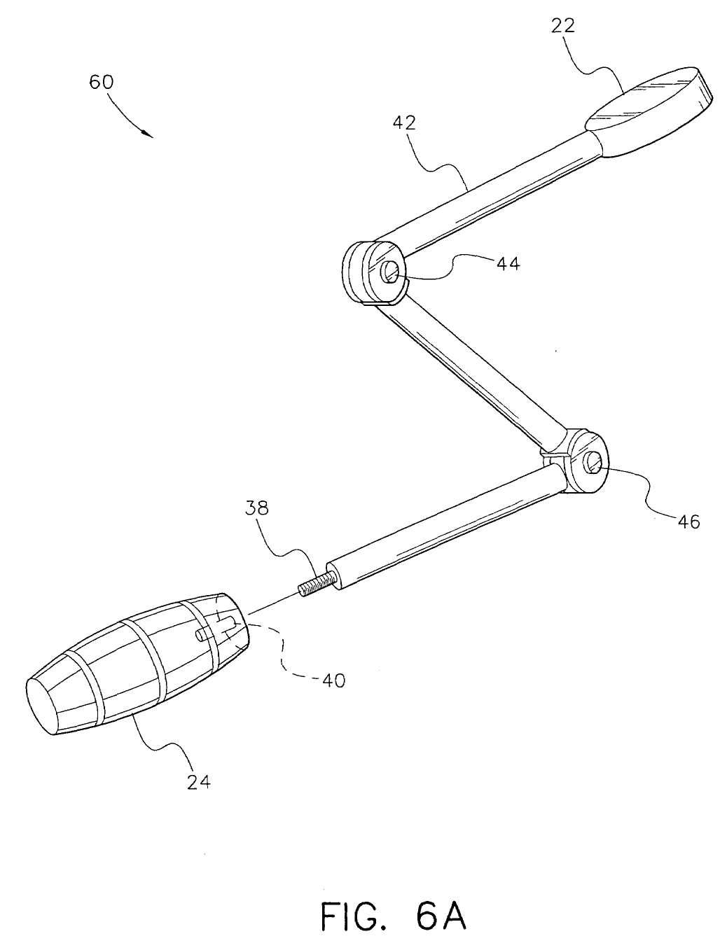

Gripping handle 24 is attached to proximal end 16 of elongated handle 12 and allows for comfortable and secure gripping of baton or stick 10 by the user. As best shown in FIG. 6A, gripping handle 24 may be releasably attached to the elongated shaft, allowing for collapse of the baton or stick and for the interchangeability and replacement of multiple gripping handles 24. Although shown as being part of the embodiment of FIG. 6A (to be described in further detail below), it should be understood that the releasably attached gripping handle 24 may be applied to the embodiment shown in FIGS. 1 and 2. Gripping handle 24 is shown as having a threaded bore 40 formed therein for releasable engagement with threaded stud 38. However, it should be understood that this is for exemplary purposes only, and gripping handle 24 may be releasably joined to the elongated shaft through the use of any suitable releasable fastener. Gripping handle 24 may be formed from rubber or any other suitable material, dependent upon the needs and desires of the user.

In FIGS. 7A-7C, an exemplary alternative cylindrical gripping handle 54 is shown attached to elongated shaft 12. Gripping handle 54 is shown as having its longitudinal axis positioned substantially orthogonal to the longitudinal axis of gripping handle 24 (of FIG. 2). Further, both FIG. 7A and FIG. 7B illustrate the gripping handle 54 being joined the elongated shaft 12 at an upper end of elongated shaft 12, while FIG. 7C illustrates gripping handle 54 being joined to elongated shaft 12 at a middle portion of gripping handle 54.

As described above with respect to the embodiment of FIG. 6A, gripping handle 24 may be releasably attached to elongated shaft 12. The engagement head 22 may be similarly releasably attached to elongated shaft 12, as shown in FIG. 6B, through threaded engagement therewith or through the use of any other suitable releasable fastener. FIG. 6B illustrates an exemplary releasable fastener in the form of threaded stud 39, which releasably engages threaded bore 41 formed in engagement head 22. Thus, gripping handle 24, elongated shaft 12 and engagement head 22 may all be selectively separated from one another, allowing for easy transport and storage of the elongated baton or stick 10. Further, the separability of gripping handle 24, elongated shaft 12 and engagement head 22 allows for the interchangeability of parts. For example, the user may wish to use the gripping handle 54 of the embodiment of FIG. 7A with the straight elongated shaft 12 of the embodiment of FIG. 7B. This allows for the adaptability of elongated baton or stick 10 to any suitable environment or positioning of the user with respect to game machine 18.

In addition to the configuration of the elongated shaft 12, as described above, the interchangeable elongated shaft 12 may be selected by the user based upon the length of shaft 12. Depending upon the positioning of the user from game machine 18, it may be desirable to provide multiple elongated shafts 12 having differing lengths. In one embodiment of the present invention, at least three separate interchangeable shafts are provided having lengths of approximately twelve inches, eighteen inches and twenty-two inches, respectively.

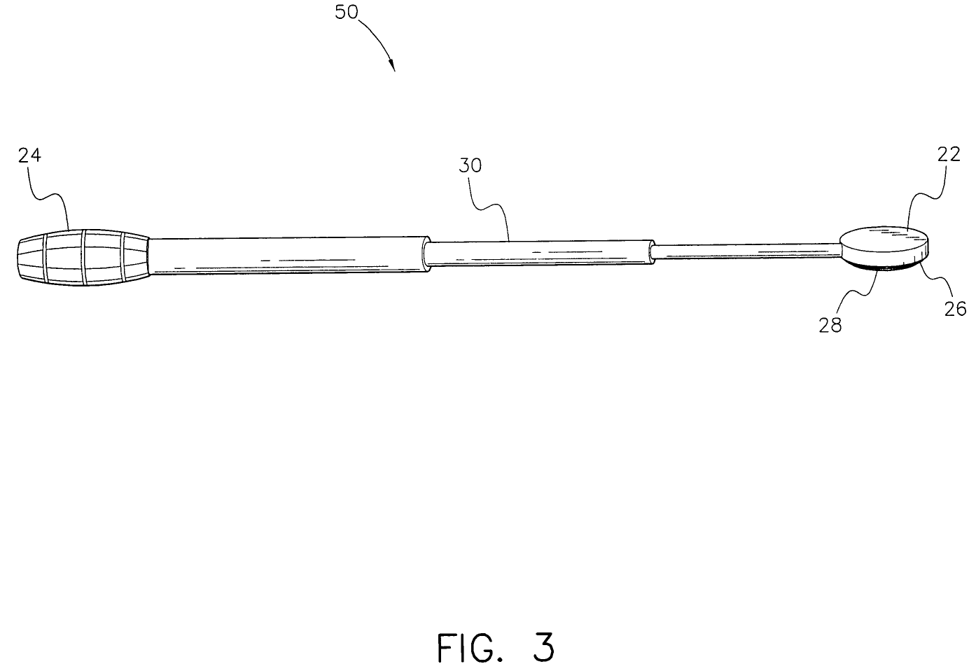

In the alternative embodiment shown in FIG. 3, slot machine baton or stick 50 includes a gripping handle 24 and an engagement head 22, similar to those shown in the embodiment of FIG. 2. The elongated shaft 12, however, is replaced in the embodiment of FIG. 3 with a telescoping shaft 30, allowing the user to adjust the distance between gripping handle 24 and engagement head 22, depending upon the user's positioning with respect to game machine 18.

The telescoping shaft 30 may be held in an extended state through frictional engagement of the telescoping portions, or the telescoping shaft 30 may be spring-loaded and include a releasable locking member, allowing the user to selectively and automatically extend the telescoping shaft 30 to its maximum length from an initially compact state. The telescoping shaft 30 may extend, for example, from approximately twelve inches when retracted to approximately twenty-two inches when extended.

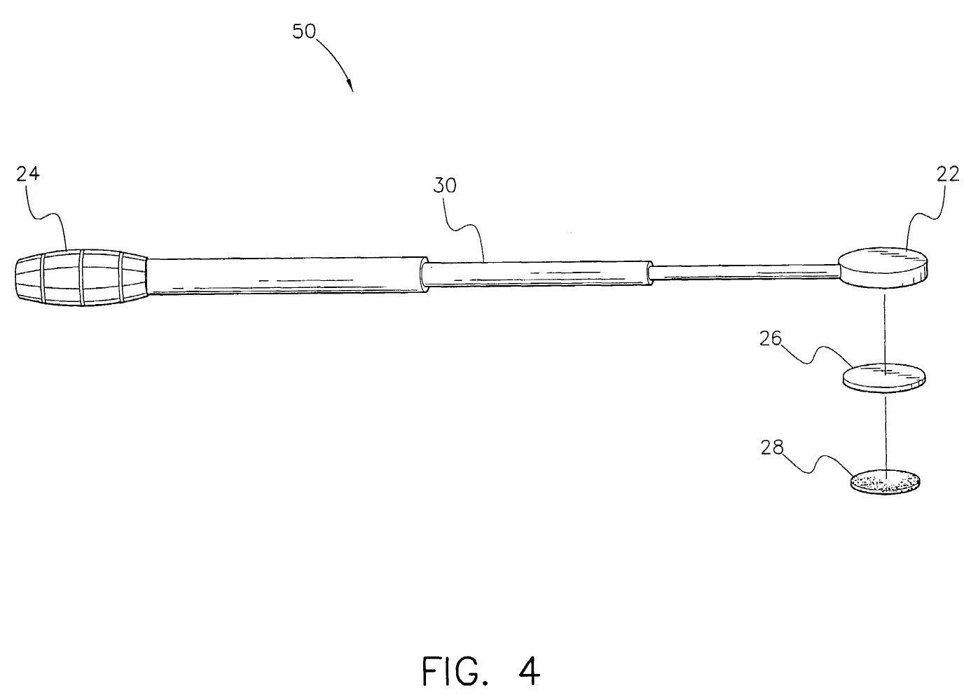

As best shown in FIG. 4, a separate weighting member 26 may be fixed to a lower surface of engagement head 22. The addition of extra weight allows the user to more easily apply actuating force to control 20. Weighting member 26 may be attached to engagement head 22 through the use of adhesives or through the use of any other suitable type of fastener. Alternatively, interchangeable engagement heads 22 having varying weights may be provided. Preferably, the weight of weighting member 26 is selected such that head 22 may rest on an actuating button 20 of gaming machine 18 without actuating button 20 (purely under the force of gravity). The additional weight is preferably selected such that the user will only have to apply a minimal amount of additional force to actuate button 20.

Further, a frictional layer 28 may be formed on a lower surface of weighting member 26. The frictional layer 28 provides for improved frictional engagement of elongated baton or stick 10 with control 20. For example, control buttons formed on video games or slot machines are often made of smooth plastic, thus increasing the chances of a user's hands slipping from the button without actuating the control. Frictional layer 28 provides for enhanced gripping, engagement and traction between elongated baton or stick 10 and control 20, reducing slipping and accidental loss of control of game machine 18. Frictional layer 28 may be formed from rubber or any other suitable material.

Although shown as having substantially disc-shaped contouring in FIGS. 3 and 4, frictional layer 28 and weighting member 26 may have any suitable size and shape, depending upon the configuration of the selected engagement head 22. In the embodiment illustrated in FIG. 8, frictional layer 28 has a substantially arcuate cross-sectional contour.

Further, engagement head 22 is shown in the Figures as having a substantially truncated cylindrical contour. It should be understood that the size and contouring of engagement head 22 are dependent upon the needs and desires of the user. Engagement head 22 may be formed from a light-weight plastic or any other suitable material, dependent upon the needs and desires of the user.

In yet another alternative embodiment, shown in FIGS. 6A and 6B, the slot machine baton or stick 60 includes a jointed shaft 42, having joints or pivot points 44 and 46. Jointed shaft 42 is adjustable in terms of both length and angular positioning of shaft 42. As described above, jointed shaft 42 may be interchanged with other shafts and used in combination with a variety of engagement heads and gripping handles. The use of jointed shaft 42 allows the user fully articulated positioning of the shaft 42, allowing for adjustment in length, height and angular position of the engagement head 22 with respect to the position of the user and the user's grip on gripping handle 24.

As shown in FIG. 5, a cover 34 may be provided for covering engagement head 22. The cover 34 may provide protection against damage to engagement head 22 and may further include indicia 36 printed thereon. A casino logo associated with gaming machine 18 may be utilized as indicia 36, or any other user-selectable indicia may be provided. Cover 34 may be formed of rubber or any other suitable resilient material. Alternatively, indicia may further be imprinted on the elongated shaft 12 or the gripping handle 24.

The alternative embodiment of FIG. 8 is similar to that shown in FIG. 5, however head 22, rather than being mounted directly to shaft 12, is mounted to a separate secondary support shaft 31. Secondary support shaft 31 is pivotally mounted to shaft 12, through use of a wing nut 29, as shown, or any other suitable releasable and adjustable pivotal fastener. The user may selectively adjust the angle between secondary support shaft 31 and shaft 12, and may further releasably lock secondary support shaft 31 in a desired angular position with respect to shaft 12.

Slot machine baton 10 allows the user to actuate button or buttons 20 of gaming machine 18 while being physically positioned away from machine 18. Thus, the user may prevent the stress and strain commonly associated with a cycle of sitting forward and leaning back, as is commonly performed in the operation of slot machines and the like. Further, by actuating button or buttons 18 with the slot machine baton 10, rather than by direct contact with the user's hand, the user is prevented from making contact with a potentially unsanitary and unhygienic surface.

It is to be understood that the present invention is not limited to the embodiments described above, but encompasses any and all embodiments within the scope of the following claims.

I claim:

1. A slot machine baton, comprising:
an elongated shaft having opposed distal and proximal ends;
a gripping handle removably attached to the proximal end of the elongated shaft;
an engagement head removably attached to the distal end of the elongated shaft, the head being adapted for releasably engaging and actuating a control of a game machine, whereby the head, the handle and the shaft are interchangeable in order to adjust the length, shape, weight and configuration of the parts of the baton.

2. The slot machine baton as recited in claim 1, wherein said elongated shaft comprises a telescoping rod.

3. The slot machine baton as recited in claim 1, further comprising a weighted member attached to a lower surface of said engagement head.

4. The slot machine baton as recited in claim 3, further comprising a frictional layer attached to a lower surface of said weighted member for frictionally engaging the control of the game machine.

5. The slot machine baton as recited in claim 1, wherein said elongated shaft comprises a main shaft portion and a secondary shaft portion, said engagement head being removably attached to a distal end of the secondary shaft portion.

6. The slot machine baton as recited in claim 5, wherein the secondary shaft portion is angled with respect to the main shaft portion.

7. The slot machine baton as recited in claim 6, wherein the main shaft portion is pivotally joined to the secondary shaft portion.

8. The slot machine baton as recited in claim 7, further comprising means for selectively and releasably securing the secondary shaft portion in a desired angular position with respect to the main shaft portion.

9. The slot machine baton as recited in claim 1, further comprising a cover layer formed on said engagement head.

10. The slot machine baton as recited in claim 9, wherein the cover layer is adapted for printing of user-selected indicia thereon.

11. The slot machine baton as recited in claim 1, wherein said elongated shaft includes a plurality of secondary shaft portions, each of the secondary shaft portions being pivotally joined to adjacent ones of the plurality of secondary shaft portions.

12. The slot machine baton as recited in claim 1, wherein said elongated shaft includes a plurality of secondary shaft portions, each of the secondary shaft portions being angled with respect to adjacent ones of the plurality of secondary shaft portions.

13. The slot machine baton as recited in claim 1, wherein said elongated shaft has a first longitudinal axis associated therewith and said gripping handle has a second longitudinal axis associated therewith, said first longitudinal axis being positioned substantially parallel to said second longitudinal axis.

14. The slot machine baton as recited in claim 1, wherein said elongated shaft has a first longitudinal axis associated therewith and said gripping handle has a second longitudinal axis associated therewith, said first longitudinal axis being positioned substantially orthogonal to said second longitudinal axis.

15. The slot machine baton as recited in claim 14, wherein said gripping handle has an upper portion, a lower portion and a central portion, the upper portion being removably attached to the proximal end of the elongated shaft.

16. The slot machine baton as recited in claim 14, wherein said gripping handle has an upper portion, a lower portion and a central portion, the central portion being removably attached to the proximal end of the elongated shaft.
